(19) United States
(12) Patent Application Publication
(10) Pub. No.: US 2019/0376328 A1
(43) Pub. Date: Dec. 12, 2019

(54) CONCEALED HINGE ASSEMBLY

(71) Applicant: Ron Zeitler, Saginaw, MI (US)

(72) Inventor: Ron Zeitler, Saginaw, MI (US)

(21) Appl. No.: 16/004,540

(22) Filed: Jun. 11, 2018

(51) Int. Cl. E05D 7/04; E05D 3/02; E05D 5/04

(52) U.S. Cl. CPC E05D 7/0423; E05D 3/02; E05D 5/04; E05Y 2900/20; E05Y 2900/132; E05D 2007/0461; E05Y 2600/63

(57) ABSTRACT

A concealed door hinge is disclosed.

### BACKGROUND OF THE INVENTION

The applicant is aware of the following prior art.

U.S. Pat. No. 4,434,523 entitled, “DOOR HINGE FOR FURNITURE DOORS OR THE LIKE” issued to Grass on Mar. 6, 1984 discloses a semi-concealed hinge for mounting a door in a relatively close adjustable operating relation with a furniture side rail or frame. A socket part is adapted to be substantially fully positioned within a backwardly and edgewise open slot in the door to carry a swing arm part on a hinged knuckle in such a manner as to enable the door to be pressure-retained in a desired position, such as in a closed position. A connector or screw-on bracket-like plate is either integral with, or secured to, the swing arm part and, if it is a separate part, has a screw and slot mounted in relation with the swing arm part that enables “up” and “down” adjustment of the door with respect to the frame. The connector or screw-on plate has opposed guide flange portions that are adapted to fit over and to be carried along opposite sides of the frame and to cooperate with an inwardly positioned adjustment plate. The adjustment plate has an elongated slot and the connector plate has a central hole for receiving a frame mounting screw that adjustably operatively secures the plates on a side edge of the frame. The adjustment and connector plates have cooperating sloped or wedge surfaces which enable the connector plate to be moved inwardly and outwardly with respect to the frame in such a manner as to effect a fully parallel adjustment of the door along the front face of the frame.

U.S. Pat. No. 7,698,783 entitled, “HINGE”, issued to Heid on Apr. 20, 2010 discloses a hinge for a door. The hinge comprises a receiver assembly having a slot, a door leaf having a retaining spring biased away from the door leaf, the door leaf being dimensioned for insertion into the slot and a retaining device associated with the receiver assembly for releasably engaging the retaining spring to releasably retain the door leaf in the slot.

U.S. Pat. No. 8,516,658 entitled, “DOOR HINGE”, in particular for a building door issued to Bultschneider on Aug. 27, 2013 discloses a door hinge that has a knuckle defining a pivot axis, a pair of leaves extending from the knuckle and pivotal relative to each other about the axis, a housing fixable in a door jamb or door edge, and a holder in the housing. The holder is formed by a pair of bent sheet-metal brackets together forming a cavity in which engages one of the hinge leaves. One of the brackets has a face forming an acute angle to the axis. A pair of rotatable and externally threaded spindles extending across the cavity are threaded to the one leaf such that rotation of the spindles adjusts a position of the one leaf in the cavity relative to the holder. An adjustment screw threaded in the housing bears on the angled face so that the screw can be rotated to press against the face and cam the holder axially. A door hinge has a knuckle defining a pivot axis, a pair of leaves extending from the knuckle and pivotal relative to each other about the axis, a housing fixable in a door jamb or door edge, and a holder in the housing. The holder is formed by a pair of bent sheet-metal brackets together forming a cavity in which engages one of the hinge leaves. One of the brackets has a face forming an acute angle to the axis. A pair of rotatable and externally threaded spindles extending across the cavity are threaded to the one leaf such that rotation of the spindles adjusts a position of the one leaf in the cavity relative to the holder. An adjustment screw threaded in the housing bears on the angled face so that the screw can be rotated to press against the face and cam the holder axially.

U.S. Pat. No. 9,670,707 entitled, “DOOR HINGE”, issued to Bartels on Jun. 6, 2017 discloses a door hinge having two hinge leaves joined together at a knuckle defining a hinge axis about which the leaves are relatively pivotal and top and bottom sheet-metal parts forming a housing surrounding one of the hinge leaves. Two rotatable adjustment spindles are each journaled in the housing, rotatable about respective axes extending in a first direction perpendicular to the hinge axis, and operatively threadedly connected to the one leaf so that rotation of the spindles moves the one leaf in a first direction perpendicular to the hinge axis. A base plate between the parts is formed with respective threaded hole receiving the spindles, the base plate being secured to the one leaf for movement of the one leaf in a second direction perpendicular to the first direction relative to the base plate.

U.S. Pat. No. 8,196,265 entitled,“CONCEALED DOOR HINGE” issued to Neukoetter on Jun. 6, 2012 discloses a concealed door hinge that has first and second leaf assemblies fittable into respective mortises in an edge of the door and in the door frame. The first leaf assembly has a body, mounting tabs at ends of the body and securable to the door frame or to an edge of the door, and an insert shiftable in the body in a first horizontal direction perpendicular to a face of the assembly. The body is also shiftable relative to the tabs in a second horizontal direction transverse to the horizontal direction and parallel to the face. A swivel mechanism is connected between the second leaf assembly and the insert of the assembly. Adjusters engaged between the insert, the body, and the tabs can relatively secure the insert and body in any of a plurality of positions offset relative to one another in the horizontal directions.

### THE INVENTION

The present invention is a concealed hinge assembly. The concealed hinge assembly comprises in combination an outer door hinge element consisting essentially of a flat front surface, a flat bottom surface, a configured back surface, a first side and a second side.

The configured back surface has an upper flat surface that has a first opening therethrough. The configured back surface has a lower flat surface that has a threaded opening therein. There is a hinge pin opening through the outer door hinge assembly from the first side to the second side.

There is an inner door hinge. This inner door hinge has a front, a back, a top, and the front has an outer door hinge element opening therein. The outer door hinge element opening has a back surface. The back surface has a second opening therethrough in an upper portion thereof. The inner door hinge has a first end and a second end and the inner door hinge has a third opening in the inner door hinge first end and in the inner door hinge second end a concealed hinge, this concealed hinge has two ends, a top, a back, and a front. The top has at least two pin openings therethrough.

The back has a hinge holder mounted therein near an outside edge thereof. The hinge holder consists of a projecting hook structure, a front end of the hook structure has a third opening therethrough.

There is an elongated hinge pin that has a narrowed portion near a center thereof.

There is a hinge pin retainer for insertion in the pin openings in the concealed hinge in addition to insertion across the narrow portion of the hinge pin retainer.

### BRIEF DESCRIPTION OF THE DRAWINGS

FIG. 1 is a view in perspective of a hinge of this invention.

FIG. 2 is a view of the hinge components in an exploded view, with a cabinet door.

FIG. 3A is a full view of a hinge of this invention installed in a door.

FIG. 3B is a close-up of FIG. 3A.

FIG. 4 is a full end view of a hinge component of this invention.

FIG. 5 is a full view of the outer door hinge from the bottom with the threaded opening shown in phantom.

FIG. 6 is a full side view of the hinge pin retainer.

FIG. 7 is a full front view of the inner door hinge.

FIG. 8 is a full view of the inner door hinge from the first end.

FIG. 9 is a full top view of the concealed hinge.

FIG. 10 is a full end view of the concealed hinge from one end.

FIG. 11 is a full front view of the concealed hinge.

FIG. 12 is a full side view of the hinge pin.

### DETAILED DESCRIPTION OF THE DRAWINGS

The present invention is a hinge that provides concealment. It has been discovered that the hinge provides concealment, security, safety and has aesthetic value.

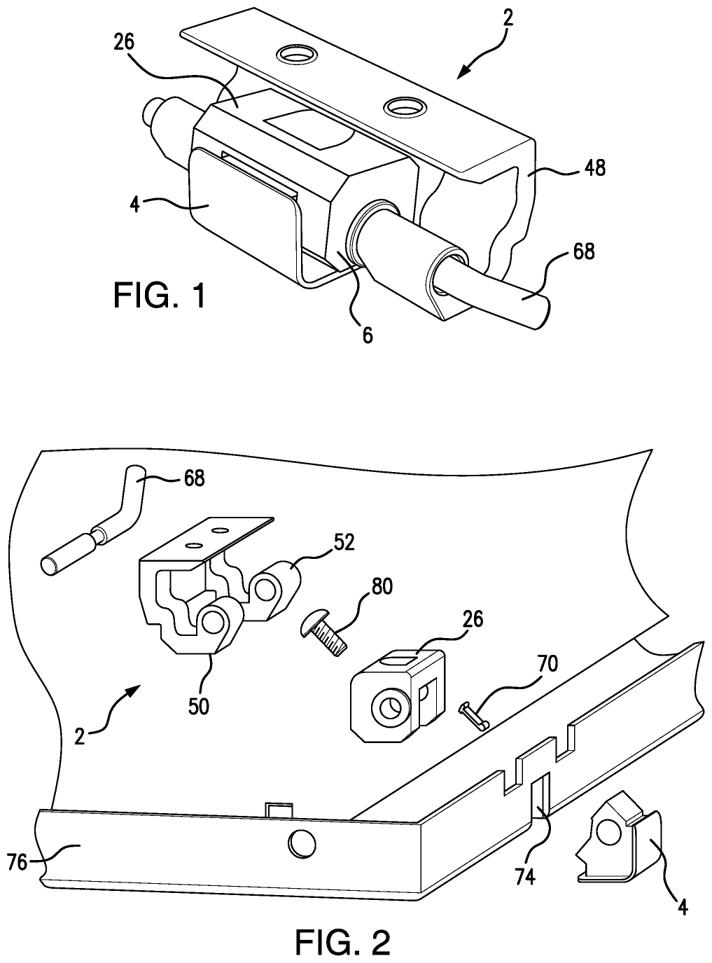

FIG. 1 shows the hinge 2. The hinge 2 has an outer door hinge element 4, an inner hinge element 26, a concealed door hinge element and a hinge pin 68.

FIG. 2 shows the hinge 2 components with a cabinet door 76. The cabinet door 76 has a special mounting hole 74 which allows the outer hinge element 4 to slide into. Once in place the inner hinge element 26 mates to the outer door hinge element 4 and is kept in place by the insertion of the hinge fastener 80. The hinge pin retainer 70 is inserted and locks the hinge pin 68 in place when it is inserted. The combined unit of the inner hinge element 26 and the outer door hinge 4 slide in between the first end 50 and the second end 52 of the concealed hinge 48 and is held in place by the hinge pin 68.

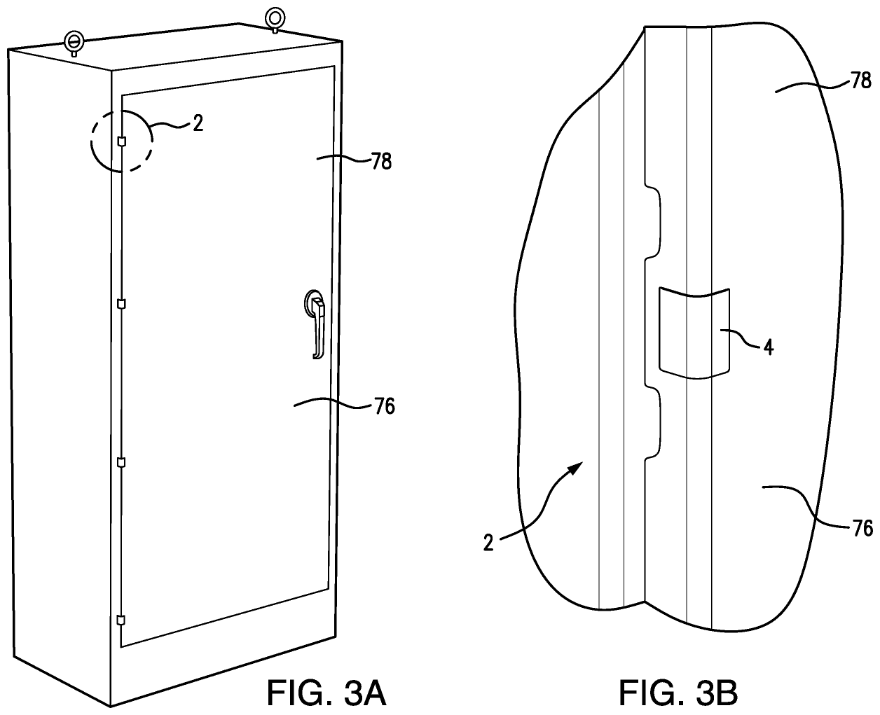

FIG. 3A shows a cabinet 78, the cabinet door 76 with the hinge 2 installed.

FIG. 3B is a close-up view of FIG. 3A and FIG. 2 is an exploded view of the hinge assembly. This shows the cabinet 78 with the cabinet door 76. The outer door hinge 4 of the hinge 2 is visible. It has been discovered that the hinge 2, cannot be removed with the door 78 closed. This creates the improved utility of safety and security. It has also been discovered that having only the outer door hinge 4 exposed improves aesthetic appearances as well.

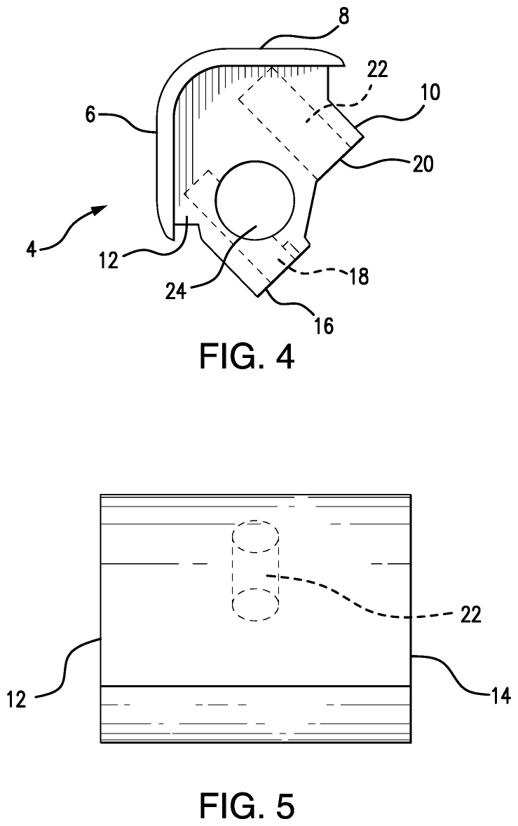

FIG. 4 shows the outer door hinge 4 from one end. This outer door hinge element 4 consists essentially of a flat front surface 6, a flat bottom surface 8, a configured back surface 10, a first side 12 and a second side 14 (Shown in FIG. 5).

The configured back surface 10 has an upper flat surface 16 that has a first opening through it 18. The configured back surface 10 has a lower flat surface 20 that has a threaded opening 22 in it. The first opening 18 accepts the hinge pin retainer 70. The hinge pin opening 24 the outer door hinge element 4 from the first side 12 to the second side 14. This first opening 18 accepts the hinge pin retainer 70 that locks the hinge pin 68 into place within the outer door hinge element 4. The first opening 18 runs from the upper flat surface 16 through to the hinge pin opening 24.

FIG. 5 show the outer door hinge 4 from the flat bottom surface 8 with the threaded opening 22 in phantom. A fastener 80 is inserted through the inner door hinge 26 into the outer door hinge element 4 locking them together.

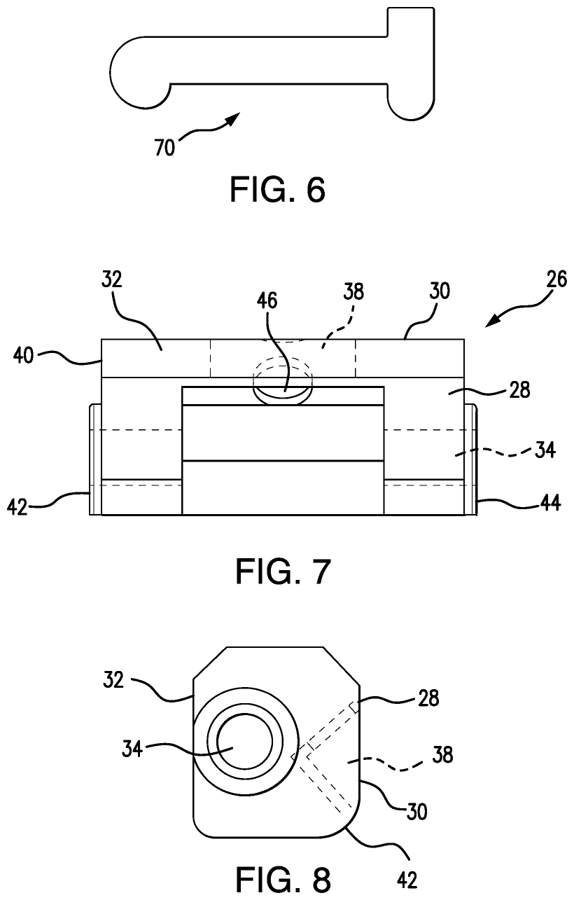

FIG. 6 shows the hinge pin retainer 70.

FIG. 7 shows the inner door hinge 26 from the front 28. This inner door hinge 26 has a front 28, a back 30, a top 32, and the front 28 has an outer door hinge element opening therein 34. The outer door hinge element opening 34 has a back surface 36. The back surface 36 has a second opening therethrough 38 in an upper portion 40 thereof. The inner door hinge 26 has a first end 42 and a second end 44 and the inner door hinge 26 has a third opening 46.

FIG. 8 shows the inner door hinge 26 from the first end 42. This shows the front 28, the back 30 and the top 32. The opening therein 38 is shown in phantom. This opening 34 is where the fastener 80 connects the inner hinge element 26 to the outer door hinge element 4 and is kept in place by the insertion of the fastener 80.

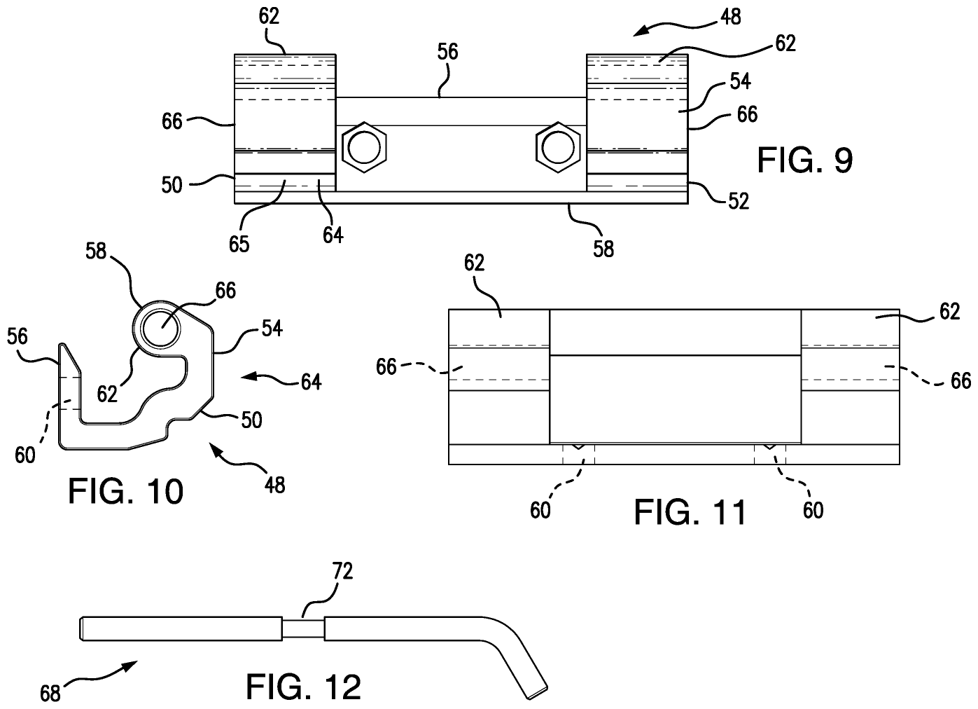

FIG. 9 shows the concealed hinge 48 from the top 54.

This concealed hinge has a first end 50 and a second end 52. The concealed hinge has a top 54, a back 56, and a front 58. The top 54 has at least two openings 60.

The back 56 has a hinge holder 62 mounted near an outside edge. The hinge holder 62 consists of a projecting hook structure 64. A front end 65 of the hook structure 64 has a third opening through 66 it.

FIG. 10 shows the concealed hinge 48 from the first end 50. The end 50 shows the top 54, a back 56, and a front 58. The top 54 has at least two openings 60. Also shown is the hinge holder 62. The hinge holder 62 consists of a projecting hook structure 64. A front end 65 of the hook structure 64 has a third opening 66 through it.

FIG. 11 shows the concealed hinge 48 from the front 58. This shows the hinge holders 62, the opening therethrough 66 and the openings 60.

FIG. 12 shows the hinge pin 68. There is an elongated hinge pin 68 that has a narrowed portion 72 near a center. The hinge pin retainer 70 is for insertion in the first opening 18 in the outer hinge element 4 in addition to insertion across the narrow portion 72 of the hinge pin 68.

What is claimed is:

1. A concealed hinge assembly, said concealed hinge assembly comprising in combination:
an outer door hinge element consisting essentially of a flat front surface, a flat bottom surface, a configured back surface, a first side and a second side;
said configured back surface having an upper flat surface having a first opening therethrough, said configured back surface having a lower flat surface having a threaded opening therein, there being a hinge pin opening through the outer door hinge assembly from said first side to said second side;
there is an inner door hinge, said inner door hinge having a front, a back, a top, and said front having an outer door hinge element opening therein, said outer door hinge element opening having a back surface, said back surface having a second opening therethrough in an upper portion thereof, said inner door hinge having a first end and a second end and said inner door hinge having a third opening in said inner door hinge first end and in said inner door hinge second end;
a concealed hinge, said concealed hinge having two ends, a top, a back, and a front, said top having at least two openings therethrough;
said back having a hinge holder mounted therein near an outside edge thereof, said hinge holder consisting of a projecting hook structure, a front end of said hook structure having a third opening therethrough;
an elongated hinge pin having a narrowed portion near a center thereof;
a hinge pin retainer for insertion in said pin openings in said concealed hinge in addition to insertion across said narrow portion of said hinge pin retainer.
